(19) United States
(12) Patent Application Publication
(10) Pub. No.: US 2014/0049403 A1
(43) Pub. Date: Feb. 20, 2014

(54) REMOTE INSPECTION SYSTEM AND COMMUNICATION METHOD THEREOF

(71) Applicant: LSIS CO., LTD., Anyang-si (KR)

(72) Inventor: Yong Woo KIM, Seoul (KR)

(73) Assignee: LSIS CO., LTD., Anyang-si (KR)

(21) Appl. No.: 13/948,960

(22) Filed: Jul. 23, 2013

(30) Foreign Application Priority Data
Aug. 16, 2012 (KR) 10-2012-0089650

(51) Int. Cl. G01D 4/00

(52) U.S. Cl. CPC G01D 4/002
USPC 340/870.02

(57) ABSTRACT

A remote inspection system and a communication method thereof are provided. According to exemplary embodiments, the system may be implemented such that desired inspection data can be received from a meter only after unlocking the meter, by setting the meter to a lock state using an inherent obis code at the beginning and receiving a corresponding unlock obis code from a remote inspection server. This may result in further enhancement of security levels of the meter and the system.

### CROSS-REFERENCE TO RELATED APPLICATION

Pursuant to 35 U.S.C. §119(a), this application claims the benefit of earlier filing date and right of priority to Korean Application No. 10-2012-0089650, filed on Aug. 16, 2012, the contents of which is incorporated by reference herein in its entirety.

### BACKGROUND OF THE DISCLOSURE

1. Field of the Disclosure

This specification relates to a remote inspection system and a communication method thereof, and particularly, to a remote inspection system capable of enhancing security of a meter by executing a lock/unlock function using obis codes, and a communication method thereof.

2. Background of the Disclosure

Device language message specification (DLMS) is a communication protocol international standard for remote inspection, which models various data handled by meters into logical objects, defines the molded logical objects as data messages in a standardized document structure, and designates a transmission method using various transmission media. The DLMS international standard is widely being applied to an inspection field of meters such as water or gas meters as well as an electric field.

A remote inspection is to read inspection data of electric meters, gas meters or water meters using a remote server, without metermen's individual visits. A remote inspection system refers to a system which a server collects and analyzes inspection data of meters installed at remote places using communication networks.

A meter and a remote server in the remote inspection system may transmit and receive data or frames using DLMS communication protocols. That is, the meter and the server generally execute DLMS communication using hexadecimal frames. Each frame may include predetermined data or information.

Taking into account the fact that the remote inspection system is considerably important data for billing with respect to power usage and the like, a security problem in external attacks is very important. In the related DLMS communication, the remote server is generally able to obtain inspection data corresponding to a meter so long as it recognizes a communication type and a frame structure, configures frames such that obis codes for calling desired inspection data can be suitable to the desired meter, and transmits the configured frames. This causes a problem in security of the remote inspection system, especially, security of the meter.

### SUMMARY OF THE DISCLOSURE

Therefore, an aspect of the detailed description is to provide a remote inspection system, capable of enhancing security in a manner of initially setting a meter to a lock state using an inherent obis code, and allowing a remote server to receive desired inspection data from the meter when the meter is unlock in response to reception of a corresponding unlock obis code from the remote server, and a communication method thereof.

To achieve these and other advantages and in accordance with the purpose of this specification, as embodied and broadly described herein, there is provided a remote inspection system including a meter having a lock function, a remote inspection server to provide an obis code value for locking or unlocking the meter, and a device language message specification (DLMS) communication modem to transmit inspection data received from the meter to the remote inspection server by applying a DLMS communication protocol when the meter is unlocked.

In accordance with one aspect, the meter may include an obis code storage unit to store an inherent lock obis code and an inherent unlock obis code, and an obis code comparator to compare an obis code value, provided by the remote inspection server through the DLMS communication modem, with the inherent lock or unlock obis code value stored in the obis code storage unit.

In accordance with one aspect, the meter may further include a controller to lock or unlock the meter. The controller may lock the meter when the obis code value provided by the remote inspection server matches the inherent lock obis code value stored, and unlock the meter when the obis code value provided by the remote inspection server matches the inherent unlock obis code value stored.

In accordance with one aspect, the obis code storage unit may be implemented as firmware.

To achieve these and other advantages and in accordance with the purpose of this specification, as embodied and broadly described herein, there is provided a communication method for a remote inspection system having a remote inspection server for receiving inspection data of a meter using a device language message specification (DLMS) communication protocol, the method including setting an inherent lock obis code and an inherent unlock obis code in the meter, generating, by the remote inspection server, an obis code for unlocking the meter and transmitting the generated obis code to the meter, comparing the transmitted unlock obis code with the inherent unlock obis code to unlock the meter when both of the codes match each other according to the comparison result, and transmitting, by the meter, inspection data corresponding to the obis code transmitted from the remote inspection server to the remote inspection server when the meter is unlocked.

In accordance with one aspect, the method may further include, prior to transmitting the obis code to the meter, transmitting, by the meter, a user agent (UA) frame to the remote inspection server, in response to a set normal response mode (SNRM) frame received from the remote inspection server, and transmitting, by the meter, an application association response (AARE) frame to the remote inspection server, in response to an application association request (AARQ) frame received from the remote inspection server.

In accordance with one aspect, the method may further include, after transmitting the inspection data to the remote inspection server, transmitting, by the remote inspection server, an obis code for locking the meter to the meter, and comparing the transmitted lock obis code with the inherent lock obis code to lock the meter when both of the codes match each other according to the comparison result.

In accordance with a remote inspection system and a communication method according to exemplary embodiment, desired inspection data may be received from a meter only after unlocking the meter, by way of setting the meter to a locked state using an inherent obis code at the beginning and receiving a corresponding unlock obis code from a remote inspection server. This may result in further enhancement of security level of the meter.

Also, with a remote inspection system and a communication method according to exemplary embodiment, without need of a separate security protocol for reinforcing security of the remote inspection system, several problems in increases in network traffic, resource consumption of a device, and fabricating costs of the device may be avoided, and safe remote inspection may be carried out.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1 is a block diagram of a remote inspection system in accordance with an exemplary embodiment of the present disclosure;

FIG. 2 is a view showing an internal configuration of a meter having a lock function in accordance with the exemplary embodiment of the present disclosure;

FIG. 3 is an exemplary flowchart showing a communication method for a remote inspection system, including a process of unlocking a meter prior to obtaining desired inspection data, in accordance with an exemplary embodiment;

FIG. 4 is an exemplary flowchart showing a communication method for a remote inspection system, including a process of locking a meter after obtaining desired inspection data, in accordance with an exemplary embodiment; and

FIG. 5 is a view showing obis code frames in accordance with exemplary embodiments.

### DETAILED DESCRIPTION OF THE DISCLOSURE

Description will now be given in detail of a remote inspection system and a communication method thereof according to the exemplary embodiments, with reference to the accompanying drawings. In describing the present invention, if a detailed explanation for a related known function or construction is considered to unnecessarily divert the gist of the present disclosure, such explanation has been omitted but would be understood by those skilled in the art.

FIG. 1 is a block diagram of a remote inspection system in accordance with an exemplary embodiment of the present disclosure. The remote inspection system may include at least one meter 100, a device language message specification (DLMS) communication modem 200 to receive inspection data from the meter 100 via a communication network, and a remote inspection server 300.

In accordance with the exemplary embodiment, the meter 100 may have a lock function. The meter 100 may have a structure that a plurality of meters 100 are connected to one remote inspection server.

In detail, the meter 100 may be locked and unlocked using pre-stored inherent lock and unlock obis codes. Here, the inherent lock obis code value and the inherent unlock obis code value may be stored in firmware at an initial designing of the meter. Such code values may preferably be perceived only by an engineer who designs communication firmware of the meter 100 or a manager of the remote inspection server 300.

The remote inspection server 300 may receive at least one inspection data from the meter 100 through the DLMS communication modem 200, collect and analyze the received inspection data, and execute a remote inspection, such as providing billing information relating to power usage. The remote inspection server 300 may further include a database (not shown) to store information, such as a MAC address, an inherent ID and the like all relating to the meter 100.

In accordance with the exemplary embodiment, the remote inspection server 300 may provide an obis code value for locking or unlocking the meter 100. Here, the obis code refers to a frame which includes an inherent number, a class ID and an attribute ID.

The DLMS communication modem 100 may apply a DLMS communication protocol to transmit inspection data input by the meter 100 to the remote inspection server 300 when the meter 100 is in an unlock state.

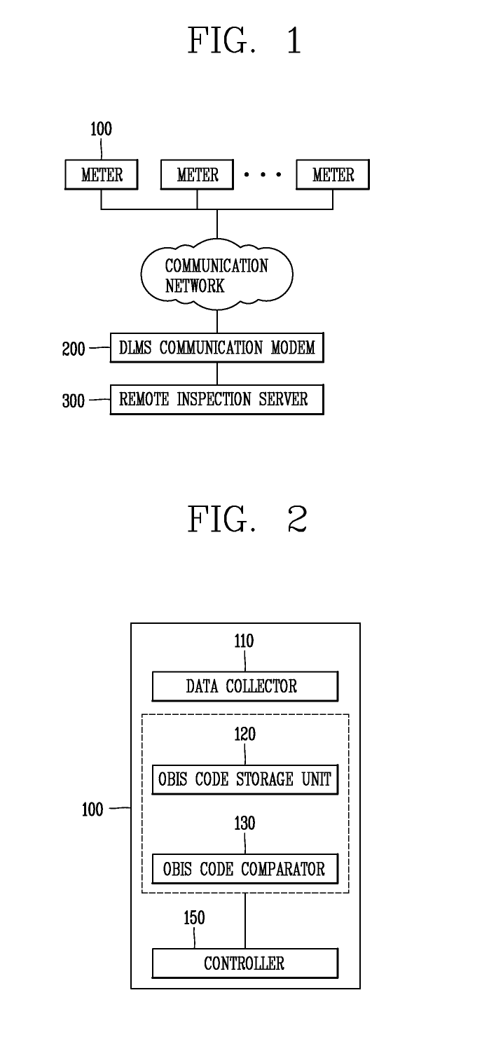

FIG. 2 is a view showing an internal configuration of the meter having the lock function. The meter 100 may include a data collector 110 to collect inspection data from meters which measure power usage, an obis code storage unit 120 and an obis code comparator 130 both relating to the lock function, and a controller 150 to lock and unlock the meter 100.

In accordance with the exemplary embodiment, the obis code storage unit 120 may be implemented as a type of firmware. That is, without an additional component for storing such inherent lock and unlock obis codes, the inherent lock and unlock obis codes may be included in a firmware built in the conventional meter 100 and the meter 100 may be merely set to a lock state at the initial installation.

The obis code comparator 130 may compare an obis code value provided from the remote inspection server 300 via the DLMS communication modem 200 with the inherent lock or unlock obis code stored in the obis code storage unit 120. Also, the obis code comparator 130 may transmit the comparison result to the controller 150 to execute the lock or unlock function.

The controller 150 may execute the lock and unlock functions of the meter 100. In detail, the controller 150 may receive the comparison result from the obis code comparator 130. When the obis code value received from the remote inspection server 300 matches the inherent lock obis code value stored in the meter 100, the controller 150 may lock the meter 100. On the other hand, when the obis code value received from the remote inspection server 300 matches the inherent unlock obis code value stored in the meter 100, the controller 150 may unlock the meter 100.

Hereinafter, description will be given of a communication method for a remote inspection system using obis codes in accordance with an exemplary embodiment.

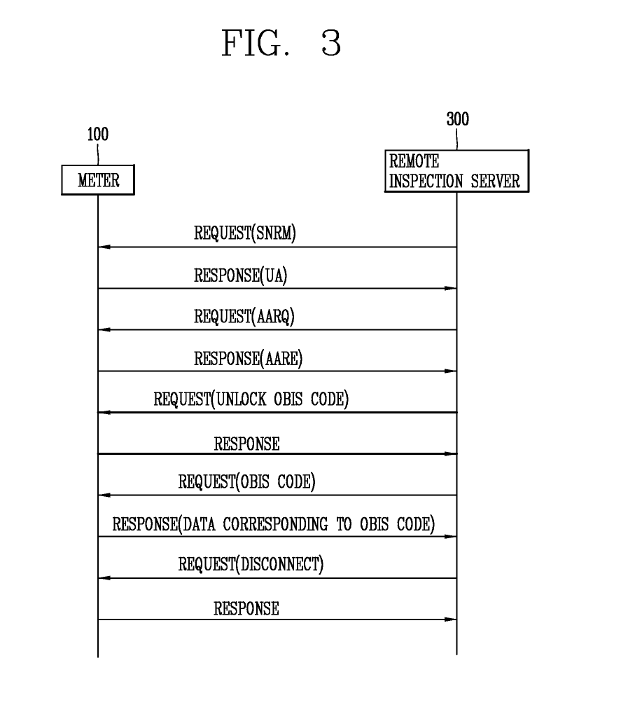

FIG. 3 shows a process of unlocking the meter prior to obtaining desired inspection data in the communication method. First of all, inherent lock and unlock obis codes may be set in the meter 100. Each obis code may include an inherent number, a class ID and an attribute ID. The inherent lock and unlock obis codes may preferably be pre-stored in firmware, which is built in the meter at an initial production.

The remote inspection server 300 may transmit a set normal response mode (SNRM) frame to the meter 100 and the meter 100, in response, may transmit a user agent (UA) frame to the remote inspection server 300.

Also, when the remote inspection server 300 transmits an application association request (AARQ) frame to the meter 100, the meter 100, in response, may transmit an application association response (AARE) frame to the remote inspection server 300.

As such, with the transmission and reception of those frames such as SNRM, UA, AARQ and AARE, an association between the meter 100 and the remote inspection server 300 may be established.

The remote inspection server 300 may then generate an unlock obis code for unlocking the meter 100 and transmit it to the meter 100. Upon reception of the unlock obis code, the meter 100 may execute an authentication.

In detail, the meter 100 may compare the unlock obis code transmitted by the remote inspection server 300 with the inherent unlock obis code stored in the meter 100. When both codes match each other according to the comparison result, the meter 100 may be unlocked.

When the transmitted unlock obis code does not match the stored inherent unlock obis code, the meter 100 may remain locked. In addition, when the unlock obis code transmitted in the locked state of the meter 100 does not match the stored inherent unlock obis code for more than a predetermined number of times (for example, 3 to 5 times), the meter 100 may not transmit a response for a predetermined time or leave a record on the remote inspection server 300 or the like, thereby more enhancing security.

When the meter 100 is unlocked, the remote inspection server 300 may transmit an obis code for receiving desired inspection data to the meter 100. The meter 100 may then transmit inspection data corresponding to the obis code, which has been transmitted by the remote inspection server 300, to the remote inspection server 300.

Upon completely receiving the desired inspection data, the remote inspection server 300 may request a disconnection from the meter 100, and in response of the meter 100 to the request, terminate the association with the meter 100. Afterwards, when the remote inspection server 300 desires to receive inspection data from the meter 100 again, as aforementioned, the remote inspection server 300 and the meter 100 may exchange those SNRM, UA, AARQ and AARE frames, establishing the association therebetween again. Accordingly, the remote inspection server 300 may transmit the obis code for requesting desired inspection data. Here, since the meter 100 has already been unlocked, the remote inspection server 300 may not have to transmit the unlock obis code again.

FIG. 4 shows a process of locking the meter again after obtaining desired inspection data in the communication method.

First of all, an association between the meter 200 and the remote inspection server 300 may be established by exchange of SNRM, UA, AARQ and AARE frames therebetween, as aforementioned with reference to FIG. 3.

When the remote inspection server 300 obtains desired inspection data from a predetermined meter 100, it may be preferable to turn the corresponding meter 100 back to a locked state.

Accordingly, after receiving all the desired inspection data, the remote inspection server 300 may transmit a lock obis code for locking the meter 100 to the meter 100. Upon reception of the lock obis code, the meter 100 may carry out an authentication.

In detail, the meter 100 may compare the received lock obis code with the inherent lock obis code stored in the meter 100. When both codes match each other according to the comparison result, the meter 100 may be locked. On the other hand, when the received lock obis code does not match the inherent lock obis code stored, the meter 100 may remain unlocked.

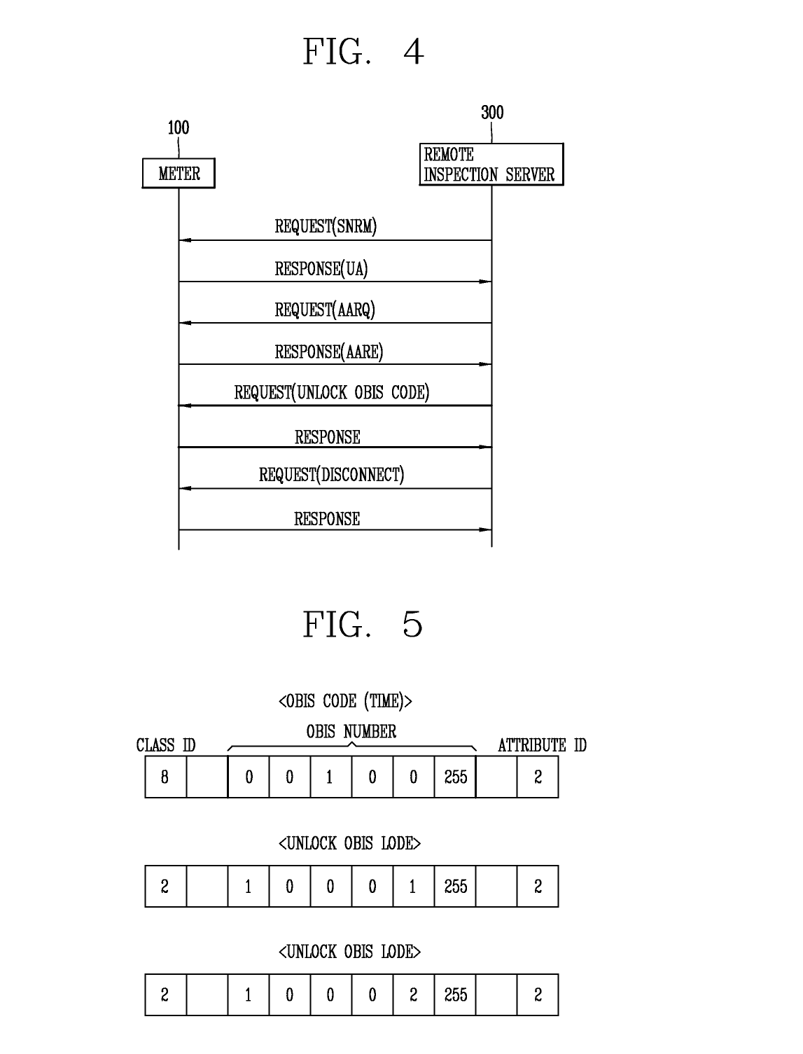

FIG. 5 is a view showing obis code frames in accordance with exemplary embodiments. As shown in FIG. 5, an obis frame may include an obis number having six inherent numbers, a class ID, and an attribute ID.

In detail, when the remote inspection server 300 desires to receive inspection time data from a predetermined meter, an obis code for requesting the inspection time data may be a frame that the class ID is 8, the obis number is ‘0 0 1 0 0 255,’ and the attribute ID is 2. Also, an obis code for locking the meter 100 may be a frame that the class ID is 2, the obis number is ‘1 0 0 0 1 255,’ and the attribute ID is 2. An obis code for unlocking the meter 100 may be a frame that the class ID is 2, the obis number is ‘1 0 0 0 2 255, and the attribute ID is 2.

In the meantime, upon starting DLMS communication between the meter 100 and the remote inspection sever 300, a process of exchanging inherent frames between the meter 100 and the remote inspection server 300 for establishing an association therebetween may be pre-performed. That is, the meter 100 and the remote inspection server 300 may establish an association therebetween by exchanging inherent frames, such as SNRM, UA, AARQ and AARE, prior to transmitting the obis code for requesting for the inspection time data, the obis code for locking the meter 100, and the obis code for unlocking the meter 100.

As described above, according to a remote inspection system and a communication method thereof according to the exemplary embodiments, desired inspection data may be received from a meter only after unlocking the meter, by way of setting the meter to a locked state using an inherent obis code at the beginning and receiving a corresponding unlock obis code from a remote inspection server. This may result in further enhancement of security level of the meter.

In addition, although not shown in the detailed description, in addition to the lock function of the meter, if an inspection data request obis code transmitted from the remote inspection server and inspection data transmitted from the meter are encoded for transmission and reception, security of the system may further be enhanced.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A remote inspection system, comprising:
a meter having a lock function;
a remote inspection server to provide an obis code value for locking or unlocking the meter; and
a device language message specification (DLMS) communication modem to transmit inspection data received from the meter to the remote inspection server by applying a DLMS communication protocol when the meter is unlocked.

2. The system of claim 1, wherein the meter comprises:
an obis code storage unit to store an inherent lock obis code and an inherent unlock obis code; and
an obis code comparator to compare an obis code value, provided by the remote inspection server through the DLMS communication modem, with the inherent lock or unlock obis code value stored in the obis code storage unit.

3. The system of claim 2, wherein the meter further comprises a controller to lock or unlock the meter,
wherein the controller locks the meter when the obis code value provided by the remote inspection server matches the inherent lock obis code stored, and unlocks the meter when the obis code value provided by the remote inspection server matches the inherent unlock obis code stored.

4. The system of claim 2, wherein the obis code storage unit is implemented as firmware.

5. A communication method for a remote inspection system having a remote inspection server for receiving inspection data of a meter using a device language message specification (DLMS) communication protocol, the method comprising:
setting an inherent lock obis code and an inherent unlock obis code in the meter;
generating, by the remote inspection server, an obis code for unlocking the meter and transmitting the generated obis code to the meter;
comparing the transmitted unlock obis code with the inherent unlock obis code, and unlocking the meter when both of the codes match each other according to the comparison result; and
transmitting, by the meter, inspection data corresponding to the obis code transmitted from the remote inspection server to the remote inspection server when the meter is unlocked.

6. The method of claim 5, further comprising, prior to transmitting the obis code to the meter:
transmitting, by the meter, a user agent (UA) frame to the remote inspection server, in response to a set normal response mode (SNRM) frame received from the remote inspection server; and
transmitting, by the meter, an application association response (AARE) frame to the remote inspection server, in response to an application association request (AARQ) frame received from the remote inspection server.

7. The method of claim 5, further comprising, after transmitting the inspection data to the remote inspection server:
transmitting, by the remote inspection server, an obis code for locking the meter to the meter; and
comparing the transmitted lock obis code with the inherent lock obis code and locking the meter when both of the codes match each other according to the comparison result.
